(19) United States
(12) Patent Application Publication
(10) Pub. No.: US 2020/0388860 A1
(43) Pub. Date: Dec. 10, 2020

(54) FUEL CELL AND FUEL CELL STACK

(71) Applicant: HONDA MOTOR CO., LTD., Tokyo (JP)

(72) Inventors: Satoru Terada, Wako-shi (JP); Takaaki Shikano, Wako-shi (JP); Takashi Kato, Wako-shi (JP); Yutaka Ebato, Wako-shi (JP); Takuma Yamawaki, Wako-shi (JP); Marina Kawano, Wako-shi (JP)

(21) Appl. No.: 16/891,115

(22) Filed: Jun. 3, 2020

(30) Foreign Application Priority Data
Jun. 5, 2019 (JP) 2019-105200

(51) Int. Cl. H01M 8/0273; H01M 8/0206; H01M 8/0258; H01M 8/2475

(52) U.S. Cl. CPC H01M 8/0273; H01M 8/2475; H01M 8/0258; H01M 8/0206

(57) ABSTRACT

An electrically insulating resin frame is provided on an outer peripheral side of a power generation section of a membrane electrode assembly forming a fuel cell of a fuel cell stack. A seal bead protruding toward the resin frame is formed on a metal separator. A metal sheet is provided in a portion of the resin frame overlapped with the seal bead as viewed in the stacking direction.

### CROSS-REFERENCE TO RELATED APPLICATION

This application is based upon and claims the benefit of priority from Japanese Patent Application No. 2019-105200 filed on Jun. 5, 2019, the contents of which are incorporated herein by reference.

### BACKGROUND OF THE INVENTION

### Field of the Invention

The present invention relates to a fuel cell and a fuel cell stack.

### Description of the Related Art

A fuel cell stack includes a stack body formed by stacking a plurality of fuel cells (power generation cells) each including a membrane electrode assembly (MEA) and a pair of separators provided on both sides of the MEA, the MEA including an electrolyte membrane and electrodes provided on both sides of the electrolyte membrane. A tightening load in the stacking direction is applied to the stack body.

Each of the pair of metal separators is provided with a seal bead protruding from a surface of the metal separator where the MEA is positioned (e.g., see Japanese Patent No. 4959190). The seal bead is pressed against an electrically insulating resin frame provided on an outer peripheral side of a power generation section of an MEA by applying a tightening load to the seal bead, to prevent leakage of fluid comprising a reactant gas or a coolant.

### SUMMARY OF THE INVENTION

The seal structure having a relatively high spring constant such as the above-described seal bead has small creep (compression permanent strain) in comparison with rubber seals, and decrease in the seal surface pressure over time is small. Therefore, the durability of the seal bead is excellent. On the other hand, since the spring constant is high, at the time of applying the tightening load, if the positions of the seal beads of the pair of metal separators are shifted from each other in a surface direction perpendicular to the stacking direction (if seal center position are shifted from each other), the resin frame is bent, and the tightening load is released in the surface direction. Therefore, deformation of the seal may occur. Under the circumstances, the seal surface of the seal bead is inclined from the surface direction, and the seal performance of the seal bead may decrease undesirably.

The present invention has been made taking the above problems into account, and an object of the present invention is to provide a fuel cell and a fuel cell stack which make it possible to achieve the desired seal performance of a seal bead.

According to an aspect of the present invention, provided is a fuel cell including: a membrane electrode assembly including an electrolyte membrane, and a cathode and an anode holding the electrolyte membrane; and a metal separator stacked on each of both sides of the membrane electrode assembly, wherein an electrically insulating resin frame is provided on an outer peripheral side of a power generation section of the membrane electrode assembly, a seal bead protruding toward the resin frame is formed on the metal separator, the seal bead is configured to prevent leakage of fluid comprising a reactant gas or a coolant, in a state where a tightening load in a stacking direction of the metal separator is applied to the seal bead, and a metal sheet is provided in a portion of the resin frame overlapped with the seal bead as viewed in the stacking direction.

According to another aspect of the present invention, provided is a fuel cell stack including a stack body comprising a plurality of stacked fuel cells each including a membrane electrode assembly and a metal separator provided on each of both sides of the membrane electrode assembly, wherein the fuel cell is the above-described fuel cell.

In the present invention, it is possible to improve the bending rigidity of the resin frame by the metal sheet.

Therefore, in the state where the positions of the seal beads are shifted from each other in the surface direction (perpendicular to the stacking direction), it is possible to reduce the situation where the tightening load is released in the surface direction. Accordingly, since it is possible to suppress deformation of the seal bead, it is possible to suppress inclination of the seal surface of the seal bead from the surface direction. Accordingly, it is possible to achieve the desired sealing performance of the seal bead.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a partial cross sectional view showing a fuel cell stack according to an embodiment of the present invention;

FIG. 2 is an exploded perspective view showing a power generation cell;

FIG. 3 is a plan view showing a first metal separator as viewed from a side where a resin frame equipped MEA is present;

FIG. 4 is a plan view showing a resin frame equipped MEA as viewed from a side where a first metal separator is present;

FIG. 5 is a cross sectional view with partial omission at a position corresponding to a line V-V in FIG. 4;

FIG. 6 is a cross sectional view showing a power generation cell according to a first modified embodiment;

FIG. 7 is a cross sectional view showing a power generation cell according to a second modified embodiment;

FIG. 8 is a cross sectional view showing a power generation cell according to a third modified embodiment of the present invention; and

FIG. 9 is a cross sectional view showing a power generation cell according to a fourth modified embodiment.

### DESCRIPTION OF THE PREFERRED EMBODIMENTS

Hereinafter, preferred embodiments of a fuel cell and a fuel cell stack according to the present invention will be described with reference the accompanying drawings.

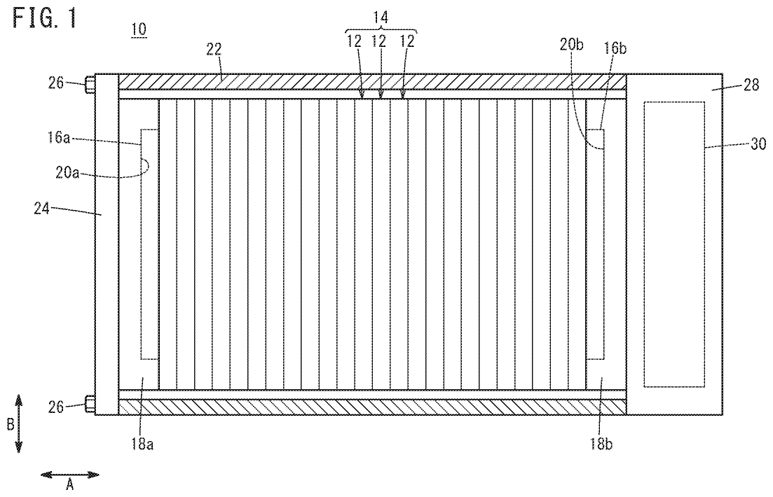

As shown in FIG. 1, a fuel cell stack 10 according to an embodiment of the present invention includes a stack body 14 formed by stacking a plurality of power generation cells 12 (fuel cells) together in a horizontal direction (indicated by an arrow A) or a gravity direction (indicated by an arrow C). It should be noted that the stacking direction of the plurality of power generation cells 12 may be the gravity direction. For example, the fuel cell stack 10 is mounted in a fuel cell vehicle such as a fuel cell electric automobile (not shown).

At one end of the stack body 14 in a stacking direction (indicated by the arrow A), a terminal plate 16a is provided. An insulator 18a is provided outside the terminal plate 16a. At the other end of the stack body 14 in the stacking direction, a terminal plate 16b is provided. An insulator 18b is provided outside the terminal plate 16b. The terminal plate 16a is disposed in a recess 20a formed in a surface of the insulator 18a facing the stack body 14. The terminal plate 16b is disposed in a recess 20b formed in a surface of the insulator 18b facing the stack body 14.

The stack body 14 is stored in a stack case 22. The stack case 22 has a quadrangular cylindrical shape. The stack case 22 covers the stack body 14 in a direction perpendicular to a stacking direction. An end plate 24 is tightened to one end of the stack case 22 using a plurality of bolts 26. The end plate 24 applies the tightening load in the stacking direction to the stack body 14. An auxiliary device case 28 is provided at the other end of the stack case 22. The auxiliary device case 28 is a protection case for protecting fuel cell auxiliary devices 30. As the fuel cell auxiliary devices 30, fuel gas system devices and oxygen-containing gas system devices are stored in the auxiliary device case 28.

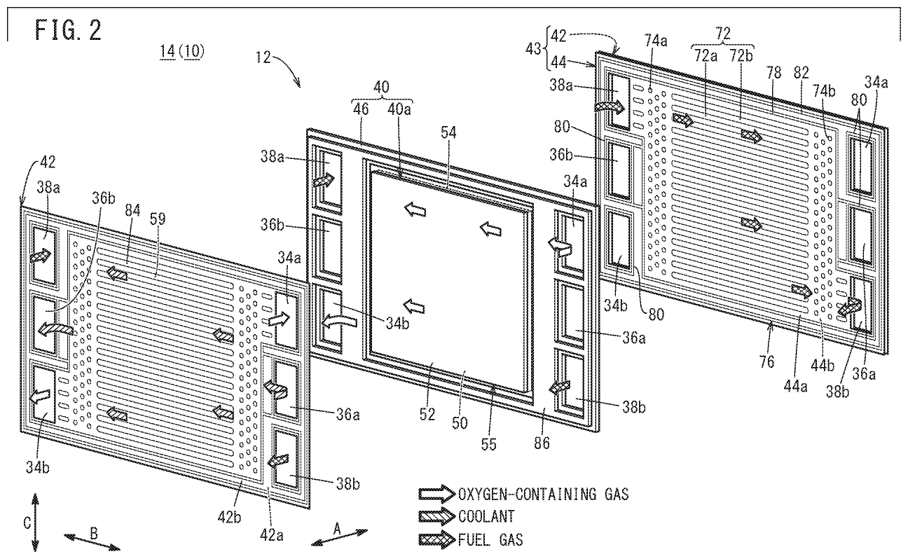

As shown in FIG. 2, at one end of the power generation cell 12 in a longitudinal direction indicated by an arrow B, an oxygen-containing gas supply passage 34a, a coolant supply passage 36a, and a fuel gas discharge passage 38b are arranged in a direction indicated by an arrow C. The oxygen-containing gas supply passage 34a extends through the power generation cells 12 in the stacking direction (indicated by the arrow A), and an oxygen-containing gas as one of reactant gases is supplied through the oxygen-containing gas supply passage 34a. The coolant supply passage 36a extends through the power generation cells 12 in the staking direction, and a coolant such as pure water, ethylene glycol or oil is supplied through the coolant supply passage 36a. The fuel gas discharge passage 38b extends through the power generation cells 12 in the stacking direction, and a fuel gas such as a hydrogen-containing gas as the other of the reactant gases is discharged through the fuel gas discharge passage 38b. At the other end of the power generation cell 12 in the direction indicated by the arrow B, a fuel gas supply passage 38a, a coolant discharge passage 36b, and an oxygen-containing gas discharge passage 34b are arranged in the direction indicated by the arrow C. The fuel gas supply passage 38a extends through the power generation cells 12 in the stacking direction, and the fuel gas is supplied through the fuel gas supply passage 38a. The coolant discharge passage 36b extends through the power generation cells 12 in the stacking direction, and the coolant is discharged through the coolant discharge passage 36b. The oxygen-containing gas discharge passage 34b extends through the power generation cells 12 in the stacking direction, and the oxygen-containing gas is discharged through the oxygen-containing gas discharge passage 34b.

The layout, the shapes, and the sizes of the oxygen-containing gas supply passage 34a, the oxygen-containing gas discharge passage 34b, the fuel gas supply passage 38a, and the fuel gas discharge passage 38b are not limited to the illustrated embodiment, and may be determined as necessary depending on the required specification.

Each of the power generation cells 12 includes a resin frame equipped MEA 40, and a first metal separator 42 and a second metal separator 44 sandwiching the resin frame equipped MEA 40. Each of the first metal separator 42 and the second metal separator 44 is formed by press forming of a metal thin plate to have a corrugated shape in cross section and a wavy shape on the surface. For example, the metal thin plate is a steel plate, a stainless steel plate, an aluminum plate, a plated steel plate, or a metal plate having an anti-corrosive surface by surface treatment.

The resin frame equipped MEA 40 includes a membrane electrode assembly (hereinafter referred to as a “MEA 40a”), and a resin frame member 46 (resin frame, resin film) joined to the outer peripheral portion of the MEA 40a and provided around the outer peripheral portion.

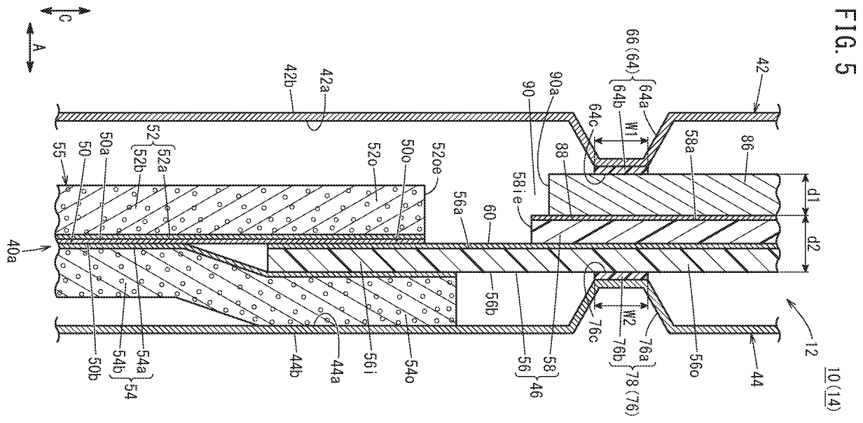

In FIG. 5, the MEA 40a includes an electrolyte membrane 50, a cathode 52 provided on one surface 50a of the electrolyte membrane 50, and an anode 54 provided on another surface 50b of the electrolyte membrane 50.

For example, the electrolyte membrane 50 is a solid polymer electrolyte membrane (cation ion exchange membrane). For example, the sold polymer electrolyte membrane is a thin membrane of perfluorosulfonic acid containing water. The electrolyte membrane 50 is interposed between the cathode 52 and the anode 54. A fluorine based electrolyte may be used as the electrolyte membrane 50. Alternatively, an HC (hydrocarbon) based electrolyte may be used as the electrolyte membrane 50.

The cathode 52 includes a first electrode catalyst layer 52a joined to one surface 50a of the electrolyte membrane 50, and a first gas diffusion layer 52b stacked on the first electrode catalyst layer 52a. The anode 54 includes a second electrode catalyst layer 54a joined to the other surface 50b of the electrolyte membrane 50, and a second gas diffusion layer 54b stacked on the second electrode catalyst layer 54a.

For example, the first electrode catalyst layer 52a is formed by porous carbon particles deposited uniformly on the surface of the first gas diffusion layer 52b together with an ion conductive polymer binder and platinum alloy supported on the surfaces of the porous carbon particles. For example, the second electrode catalyst layer 54a is formed by porous carbon particles deposited uniformly on the surface of the second gas diffusion layer 54b together with an ion conductive polymer binder and platinum alloy supported on the surfaces of the porous carbon particles. Each of the first gas diffusion layer 52b and the second gas diffusion layer 54b comprises a carbon paper, a carbon cloth, etc.

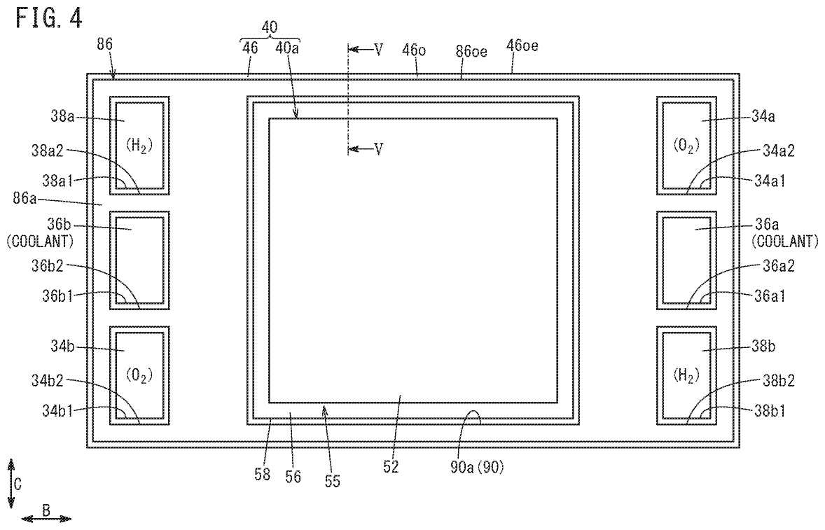

As shown in FIGS. 2 and 4, at one end of the resin frame member 46 in the direction indicated by the arrow B, the oxygen-containing gas supply passage 34a, the coolant supply passage 36a, and the fuel gas discharge passage 38b are provided. At the other end of the resin frame member 46 in the direction indicated by the arrow B, the fuel gas supply passage 38a, the coolant discharge passage 36b, and the oxygen-containing gas discharge passage 34b are provided.

In FIGS. 4 and 5, the resin frame member 46 is provided in the form of a frame on the outer peripheral side of a power generation section 55. The resin frame member 46 has a quadrangular ring shape. The resin frame member 46 includes a film body 56 and a reinforcement film 58.

The film body 56 is provided on an outer peripheral portion of the power generation section 55. Specifically, an inner peripheral portion 56i of the film body 56 is sandwiched between an outer peripheral portion 52o of the cathode 52 and an outer peripheral portion 54o of the anode 54. Stated otherwise, the inner peripheral portion 56i of the film body 56 is provided between an outer peripheral portion 50o of the electrolyte membrane 50 and the outer peripheral portion 54o of the anode 54. It should be noted that the inner peripheral portion 56i of the film body 56 may be provided between the electrolyte membrane 50 and the outer peripheral portion 52o of the cathode 52.

The electrolyte membrane 50 is joined, by an adhesive layer 60 made of adhesive, to a surface 56a of the film body 56 where the cathode 52 (electrolyte membrane 50) is positioned. The adhesive layer 60 is provided over the entire surface 56a of the film body 56. The adhesive of the adhesive layer 60 is not limited to liquid, solid, thermoplastic, or thermosetting adhesive, etc.

The reinforcement film 58 is joined to an outer peripheral portion 56o of the surface 56a of the film body 56 by the adhesive layer 60. That is, the reinforcement film 58 is not provided on a surface 56b of the film body 56 where the anode 54 is positioned. An inner peripheral end 58ie of the reinforcement film 58 faces an outer peripheral end 52oe of the cathode 52 through a gap over the entire periphery, outside the outer peripheral end 52oe.

The resin frame member 46 is not limited to the structure where the film body 56 and the reinforcement film 58 are joined together through the adhesive layer 60. The resin frame member 46 may comprise the film body 56 and the reinforcement film 58 that are formed integrally entirely. Further, the resin frame member 46 may not be limited to the stepped shape having a relatively thin inner peripheral portion and a relatively thick outer peripheral portion. The resin frame member 46 may have a shape without any steps from the inner peripheral portion to the outer peripheral portion (substantially flat shape). The film body 56 and the reinforcement film 58 have the same thickness. It should be noted that the film body 56 may be thicker than, or thinner than the reinforcement film 58.

The film body 56 and the reinforcement film 58 are made of electrically insulating resin material. For example, the film body 56 and the reinforcement film 58 are made of PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin.

Instead of using the resin frame member 46, it may be possible to adopt structure where the electrolyte membrane 50 protrudes outward, and the protruding portion serves as the film body 56.

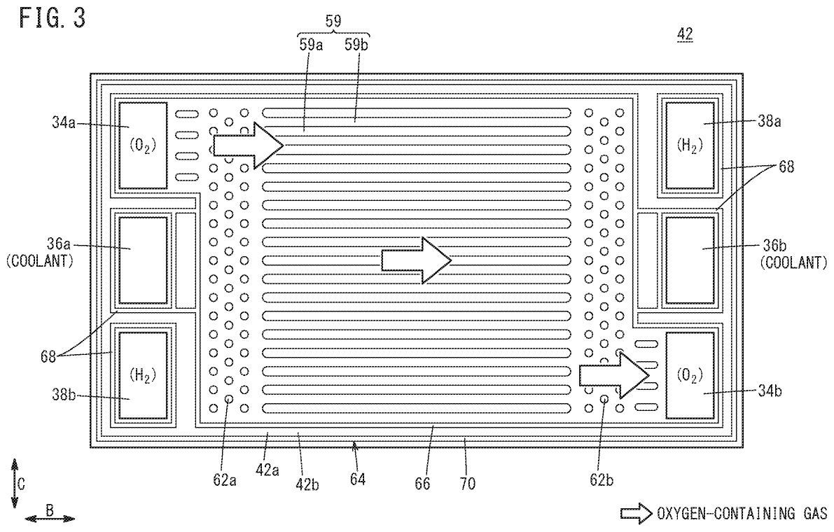

As shown in FIG. 3, the first metal separator 42 has, on its surface 42a facing the resin frame equipped MEA 40, an oxygen-containing gas flow field 59 (reactant gas flow field) extending, for example, in the direction indicated by the arrow B. The oxygen containing gas flow field 59 is connected to (in fluid communication with) the oxygen-containing gas supply passage 34a and the oxygen-containing gas discharge passage 34b. The oxygen-containing gas flow field 59 includes straight flow grooves (or wavy flow grooves) 59b between a plurality of ridges 59a extending in the direction indicated by the arrow B.

An inlet buffer 62a is provided between the oxygen-containing gas supply passage 34a and the oxygen-containing gas flow field 59. The inlet buffer 62a is formed integrally with the first metal separator 42 by press forming, and includes a plurality of bosses. An outlet buffer 62b including a plurality of bosses is provided between the oxygen-containing gas discharge passage 34b and the oxygen-containing gas flow field 59 by press forming.

A seal bead 64 for preventing leakage of fluid (the fuel gas, the oxygen-containing gas, and the coolant) is formed on the surface 42a of the first metal separator 42. In FIG. 5, the seal bead 64 includes a bead body 64a protruding integrally from the first metal separator 42 toward the resin frame member 46, and a resin member 64b fixed to the protruding end surface of the bead body 64a by printing or coating.

In the state where the tightening load is applied to the bead body 64a in the stacking direction, the bead body 64a has a trapezoidal shape in lateral cross section. It should be noted that the lateral cross sectional shape of the bead body 64a can be changed as necessary, and may be a circular arc shape, for example. The resin member 64b may be dispensed with. The protruding end surface (seal surface 64c) of the seal bead 64 contacts a metal sheet 86 (described later) provided on the resin frame member 46. The protruding end surface (contact surface) of the seal bead 64 has a flat shape. The seal bead 64 has seal structure where the seal bead 64 tightly contacts the metal sheet 86 and is elastically deformed by the tightening load in the stacking direction to seal the portion between the seal bead 64 and the metal sheet 86 in an air tight and liquid tight manner.

In FIG. 3, the seal bead 64 includes an inner bead 66, a plurality of passage beads 68, and an outer bead 70. The inner bead 66 is provided around the oxygen-containing gas flow field 59, the oxygen-containing gas supply passage 34a, and the oxygen-containing gas discharge passage 34b. The plurality of passage beads 68 are provided around the fuel gas supply passage 38a, the fuel gas discharge passage 38b, the coolant supply passage 36a, and the coolant discharge passage 36b, respectively. The outer bead 70 is provided around the outer marginal portion of the first metal separator 42. It should be noted that the outer bead 70 may be provided as necessary and may be dispensed with.

As shown in FIG. 2, the second metal separator 44 has, on its surface 44a facing the resin frame equipped MEA 40, a fuel gas flow field 72 (reactant gas flow field) extending, for example, in the direction indicated by the arrow B. The fuel gas flow field 72 is connected to (in fluid communication with) the fuel gas supply passage 38a and the fuel gas discharge passage 38b. The fuel gas flow field 72 includes straight flow grooves (or wavy flow grooves) 72b between a plurality of ridges 72a extending in the direction indicated by the arrow B.

An inlet buffer 74a is provided between the fuel gas supply passage 38a and the fuel gas flow field 72. The inlet buffer 74a is formed integrally with the second metal separator 44 by press forming, and includes a plurality of bosses. An outlet buffer 74b including a plurality of bosses is provided between the fuel gas discharge passage 38b and the fuel gas flow field 72 by press forming. A seal bead 76 for preventing leakage of fluid (the fuel gas, the oxygen-containing gas, and the coolant) is formed on the surface 44a of the second metal separator 44. In FIG. 5, the seal bead 76 includes a bead body 76a protruding integrally from the second metal separator 44 toward the resin frame member 46, and a resin member 76b fixed to the protruding end surface of the bead body 76a by printing or coating. A flat top part of the seal bead 64 and a flat top part of the seal bead 76 are positioned to face each other on both sides of (sandwiching) the resin frame member 46 and the metal sheet 86 (described later). A width W1 of the top part of the seal bead 64 and a width W2 of the top part of the seal bead 76 are substantially the same.

In the state where the tightening load is applied to the bead body 76a in the stacking direction, the bead body 76a has a trapezoidal shape in lateral cross section. It should be noted that the lateral cross sectional shape of the bead body 76a can be changed as necessary, and may be a circular arc shape, for example. The resin member 76b may be dispensed with. The protruding end surface (seal surface 76c) of the seal bead 76 contacts the resin frame member 46 (the other surface 56b of the film body 56). The protruding end surface (contact surface) of the seal bead 76 has a flat shape. The seal bead 76 has seal structure where the seal bead 76 tightly contacts the resin frame member 46 and is elastically deformed by the tightening load in the stacking direction to seal the portion between the seal bead 76 and the resin frame member 46 in an air tight and liquid tight manner.

In FIG. 2, the seal bead 76 includes an inner bead 78, a plurality of passage beads 80, and an outer bead 82. The inner bead 78 is provided around the fuel gas flow field 72, the fuel gas supply passage 38a, and the fuel gas discharge passage 38b. The plurality of passage beads 80 are provided around the oxygen-containing gas supply passage 34a, the oxygen-containing gas discharge passage 34b, the coolant supply passage 36a, and the coolant discharge passage 36b, respectively. The outer bead 82 is provided around the outer marginal portion of the second metal separator 44. It should be noted that the outer bead 82 may be provided as necessary and may be dispensed with.

As shown in FIG. 2, outer ends of the first metal separator 42 and the second metal separator 44 are joined together by welding, brazing, etc. to form a joint separator 43. A coolant flow field 84 is formed between a back surface 42b of the first metal separator 42 and a back surface 44b of the second metal separator 44. The coolant flow field 84 is connected to (in fluid communication with) the coolant supply passage 36a and the coolant discharge passage 36b. When the first metal separator 42 and the second metal separator 44 are stacked together, the coolant flow field 84 is formed on the back surface of the oxygen-containing gas flow field 59 formed on the first metal separator 42 and the back surface of the fuel gas flow field 72 formed on the second metal separator 44.

As shown in FIGS. 2, 4, and 5, the metal sheet 86 is provided at a position of the resin frame member 46 overlapped with the seal bead 76 as viewed in the stacking direction (indicated by the arrow A). Stated otherwise, in FIG. 5, the metal sheet 86 is joined to a surface 58a of the reinforcement film 58 on the side opposite to the film body 56, by an adhesive layer 88 made of adhesive. The adhesive layer 88 is provided over the entire surface 58a of the reinforcement film 58. The adhesive layer 88 has the same structure as the adhesive layer 60. The metal sheet 86 is provided only on a surface of the resin frame member 46 (surface 58a of the reinforcement film 58) where the cathode 52 is positioned. The metal sheet 86 is not provided on a surface of the resin frame member 46 (surface 56b of the film body 56) where the anode 54 is positioned.

The metal sheet 86 and the resin frame member 46 are held between the seal bead 64 and the seal bead 76. That is, seal surfaces 64c of the seal beads 64 (the inner bead 66, the plurality of passage beads 68, and the outer bead 70) contact the metal sheet 86. Seal surfaces 76c of the seal beads 76 (the inner bead 78, the plurality of passage beads 80, and the outer bead 82) contact the film body 56.

Examples of material of the metal sheet 86 include titanium, titanium alloy, iron alloy such as stainless steel, aluminum, aluminum alloy, copper, copper alloy, etc. A surface treatment may be applied to a surface of the metal sheet 86 to have at least one of anti-corrosive property and electrically insulating property. The elasticity of the metal sheet 86 is higher than the elasticity of the resin frame member 46.

A thickness d1 of the metal sheet 86 in the stacking direction is smaller than a thickness d2, in the stacking direction, of a portion (outer peripheral portion) of the resin frame member 46 where the metal sheet 86 is provided. The thickness d2 of the resin frame member 46 is the sum of the thickness of the film body 56, the thickness of the adhesive layer 60, the thickness of the reinforcement film 58, and the thickness of the adhesive layer 88 in the stacking direction. The thickness d1 of the metal sheet 86 in the stacking direction is larger than the thickness of the film body 56 and the thickness of the reinforcement film 58 in the stacking direction. It should be noted that the thickness d1 of the metal sheet 86 in the stacking direction may be smaller than the thickness of the film body 56 and the thickness of the reinforcement film 58 in the stacking direction.

In FIG. 4, the metal sheet 86 has a quadrangular shape which surrounds the power generation section 55. An outer peripheral end 86oe of the metal sheet 86 is positioned inside an outer peripheral end 46oe of the resin frame member 46 over the entire periphery. Stated otherwise, an outer peripheral portion 46o of the resin frame member 46 protrudes outside the metal sheet 86 over the entire periphery. The outer size of the metal sheet 86 is slightly smaller than the outer size of the resin frame member 46.

Therefore, even if water condensation occurs in the outer peripheral end of the metal sheet 86 or an electrically conductive member is attached to the outer peripheral end of the metal sheet, it is possible to effectively suppress the situation where the first metal separator 42 and the second metal separator 44 are connected together electrically (short circuited) through the metal sheet 86. It should be noted that the protruding length of the outer peripheral portion 46o of the resin frame member 46 from the metal sheet 86 can be determined as necessary.

A central hole 90, in which the cathode 52 (power generation section 55) is disposed, is formed in the metal sheet 86. As viewed in the stacking direction, the central hole 90 has a quadrangular shape, and is slightly larger than the cathode 52. That is, as shown in FIG. 5, an inner surface 90a of the central hole 90 faces the outer peripheral end 52oe of the cathode 52 through a gap over the entire periphery, outside the outer peripheral end 52oe. The inner surface 90a of the central hole 90 is positioned outside the inner peripheral end 58ie of the reinforcement film 58 over the entire periphery. It should be noted that the inner surface 90a of the central hole 90 may be positioned inside the inner peripheral end 58ie of the reinforcement film 58 over the entire periphery. Further, the inner surface 90a of the central hole 90 may be continuous with the inner peripheral end 58ie of the reinforcement film 58 over the entire periphery without any steps.

As shown in FIG. 4, at one end of the metal sheet 86 in the direction indicated by the arrow B, the oxygen-containing gas supply passage 34a, the coolant supply passage 36a, and the fuel gas discharge passage 38b are provided. The oxygen-containing gas supply passage 34a of the metal sheet 86 is slightly larger than the oxygen-containing gas supply passage 34a of the resin frame member 46. An inner surface 34a1 forming the oxygen-containing gas supply passage 34a in the resin frame member 46 protrudes inside of an inner surface 34a2 forming the oxygen-containing gas supply passage 34a in the metal sheet 86 over the entire periphery.

The coolant supply passage 36a of the metal sheet 86 is slightly larger than the coolant supply passage 36a of the resin frame member 46. An inner surface 36a1 forming the coolant supply passage 36a in the resin frame member 46 protrudes inside of an inner surface 36a2 forming the coolant supply passage 36a in the metal sheet 86 over the entire periphery. The fuel gas discharge passage 38b of the metal sheet 86 is slightly larger than the fuel gas discharge passage 38b of the resin frame member 46. An inner surface 38b1 forming the fuel gas discharge passage 38b in the resin frame member 46 protrudes inside of an inner surface 38b2 forming the fuel gas discharge passage 38b in the metal sheet 86 over the entire periphery.

At the other end of the metal sheet 86 in the direction indicated by the arrow B, the fuel gas supply passage 38a, the coolant discharge passage 36b, and the oxygen-containing gas discharge passage 34b are provided. The fuel gas supply passage 38a of the metal sheet 86 is slightly larger than the fuel gas supply passage 38a of the resin frame member 46. An inner surface 38a1 forming the fuel gas supply passage 38a in the resin frame member 46 protrudes inside of an inner surface 38a2 forming the fuel gas supply passage 38a in the metal sheet 86 over the entire periphery.

The coolant discharge passage 36b of the metal sheet 86 is slightly larger than the coolant discharge passage 36b of the resin frame member 46. An inner surface 36b1 forming the coolant discharge passage 36b in the resin frame member 46 protrudes inside of an inner surface 36b2 forming the coolant discharge passage 36b in the metal sheet 86 over the entire periphery. The oxygen containing gas discharge passage 34b of the metal sheet 86 is slightly larger than the oxygen-containing gas discharge passage 34b of the resin frame member 46. An inner surface 34b1 forming the oxygen-containing gas discharge passage 34b in the resin frame member 46 protrudes inside of an inner surface 34b2 forming the oxygen-containing gas discharge passage 34b in the metal sheet 86 over the entire periphery.

Therefore, even in the case where the water produced in the electrochemical reactions in the power generation cells 12 flows through the reactant gas passages (the oxygen-containing gas supply passage 34a, the oxygen-containing gas discharge passage 34b, the fuel gas supply passage 38a, and the fuel gas discharge passage 38b), it is possible to prevent the first metal separator 42 and the second metal separator 44 from being connected electrically to each other. Accordingly, it is possible to prevent corrosion of the first metal separator 42 and the second metal separator 44.

Operation of the fuel cell stack 10 having the above structure will be described below.

As shown in FIG. 2, the oxygen-containing gas flows from the oxygen-containing gas supply passage 34a into the oxygen-containing gas flow field 59 of the first metal separator 42. The oxygen-containing gas flows along the oxygen-containing gas flow field 59 in the direction indicated by the arrow B, and the oxygen-containing gas is supplied to the cathode 52 of the MEA 40a.

In the meanwhile, as shown in FIG. 2, the fuel gas flows from the fuel gas supply passage 38a into the fuel gas flow field 72 of the second metal separator 44. The fuel gas flows along the fuel gas flow field 72 in the direction indicated by the arrow B, and the fuel gas is supplied to the anode 54 of the MEA 40a.

Thus, in each of the MEAs 40a, the oxygen-containing gas supplied to the cathode 52 and the fuel gas supplied to the anode 54 are partially consumed in electrochemical reactions in the second electrode catalyst layer 54a and the first electrode catalyst layer 52a to perform power generation.

Then, after the oxygen-containing is supplied to the cathode 52 and partially consumed at the cathode 52, the oxygen-containing gas is discharged along the oxygen-containing gas discharge passage 34b in the direction indicated by the arrow A. Likewise, after the fuel gas is supplied to the anode 54 and partially consumed at the anode 54, the fuel gas is discharged along the fuel gas discharge passage 38b in the direction indicated by the arrow A.

Further, the coolant supplied to the coolant supply passage 36a flows into the coolant flow field 84 formed between the first metal separator 42 and the second metal separator 44, and then, flows in the direction indicated by the arrow B. After the coolant cools the MEA 40a, the coolant is discharged from the coolant discharge passage 36b.

The embodiment of the present invention offers the following advantages.

The metal sheet 86 is provided at the position of the resin frame member 46 overlapped with the seal beads 64, 76 as viewed in the stacking direction.

In the structure, it is possible to improve the bending rigidity of the resin frame member 46 by the metal sheet 86. Therefore, as shown in FIG. 5, in the state where the seal bead 64 and the seal bead 76 are shifted from each other in the surface direction (perpendicular to the stacking direction), even if a tightening load in the stacking direction is applied, flexure of the resin frame member 46 is suppressed, whereby it is possible to reduce the situation where the tightening load is released in the surface direction. As a result, since deformation of the seal beads 64, 76 is suppressed, it is possible to suppress inclination of the seal surfaces 64c, 76c of the seal beads 64, 76 from the surface direction. Therefore, it is possible to achieve the desired sealing performance of the seal beads 64, 76.

The resin frame member 46 includes the film body 56 provided in the outer peripheral portion of the power generation section 55, and the reinforcement film 58 joined to the outer peripheral portion 56o of the film body 56.

In the structure, it is possible to improve the rigidity in the outer peripheral portion of the resin frame member 46 while reducing the thickness of the outer peripheral portion of the power generation section 55 in the stacking direction.

The elasticity of the metal sheet 86 is higher than the elasticity of the resin frame member 46.

In the structure, it is possible to effectively increase the rigidity of the resin frame member 46 by the metal sheet 86.

The thickness d1 of the metal sheet 86 in the stacking direction is smaller than the thickness d2, in the stacking direction, of a portion of the resin frame member 46 where the metal sheet 86 is provided.

In the structure, the outer peripheral portion of the power generation cell 12 can be made relatively thin.

The plurality of passages (the oxygen-containing gas supply passage 34a, the oxygen-containing gas discharge passage 34b, the coolant supply passage 36a, the coolant discharge passage 36b, the fuel gas supply passage 38a, and the fuel gas discharge passage 38b) extend through the first metal separator 42 in the stacking direction. The metal sheet 86 extends around the power generation section 55 and these passages.

In the structure, the flow of the fluid (the oxygen-containing gas, the fuel gas, and the coolant) is not obstructed by the metal sheet 86.

### First Modified Embodiment

Next, a power generation cell 12a according to a first modified embodiment will be described. The constituent elements of the power generation cell 12a according to the first modified embodiment having the structure identical to those of the power generation cell 12 as described above are labeled with the same reference numerals, and description thereof is omitted. This applies to power generation cells 12b to 12d in second to fourth modified embodiments described later.

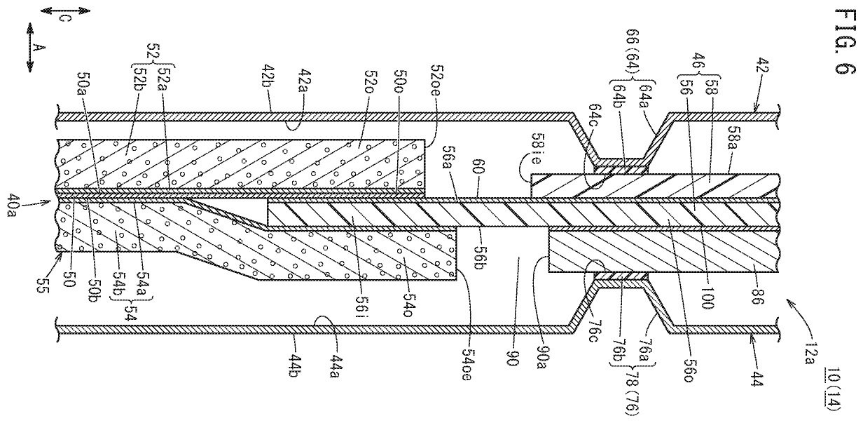

As shown in FIG. 6, in the power generation cell 12a according to the first modified embodiment, the metal sheet 86 is joined to the surface 56b of the film body 56 where the anode 54 is positioned by an adhesive layer 100 made of adhesive. The adhesive layer 100 used herein may be the same as the above-described adhesive layer 60. That is, the metal sheet 86 is provided only on a surface of the resin frame member 46 where the anode 54 is positioned (surface 56b of the film body 56), and the metal sheet 86 is not provided on a surface of the resin frame member 46 where the cathode 52 is positioned (surface 58a of the reinforcement film 58).

In this case, the seal surface 64c of the seal bead 64 contacts the reinforcement film 58. The seal surface 76c of the seal bead 76 contacts the metal sheet 86. The inner surface 90a forming the central hole 90 in the metal sheet 86 faces an outer peripheral end 54oe of the anode 54 through a gap over the entire periphery, outside the outer peripheral end 54oe.

In the structure, the same advantages as in the case of the above-described power generation cell 12 are obtained.

### Second Modified Embodiment

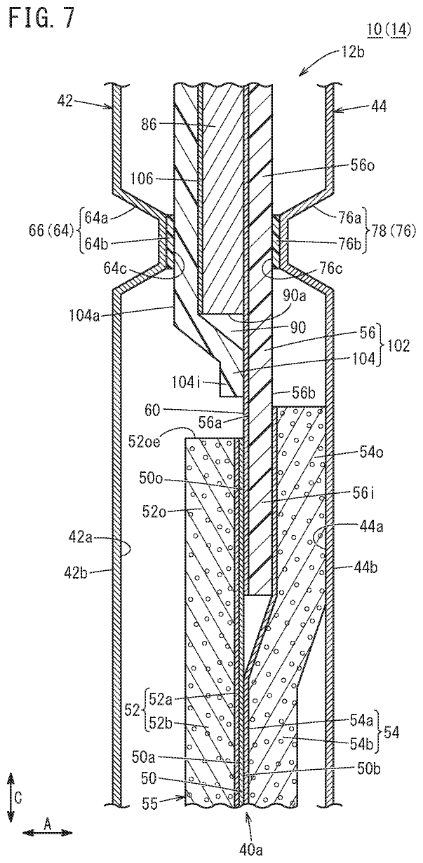

As shown in FIG. 7, in the power generation cell 12b according to the second modified embodiment, the metal sheet 86 is enclosed in a resin frame member 102. Specifically, the metal sheet 86 is joined to the surface 56a of the film body 56 by the adhesive layer 60. A reinforcement film 104 is joined to the metal sheet 86 by an adhesive layer 106 made of adhesive in a manner to cover the entire metal sheet 86 from a side where the cathode 52 (first metal separator 42) is positioned.

The reinforcement film 104 is an electrical insulating film. An inner peripheral portion 104i of the reinforcement film 104 is joined to the surface 56a of the film body 56 by the adhesive layer 60 in a manner to cover the inner surface 90a forming the central hole 90 of the metal sheet 86 over the entire periphery. Although not shown in detail, an outer peripheral portion of the reinforcement film 104 is joined to the surface 56a of the film body 56 by the adhesive layer 60 in a manner to cover the outer peripheral end 86oe of the metal sheet 86 over the entire periphery.

In this case, the seal surface 64c of the seal bead 64 contacts a surface 104a of the reinforcement film 104. The seal surface 76c of the seal bead 76 contacts the surface 56b of the film body 56.

In the structure, the same advantages as in the case of the above-described power generation cell 12 are obtained.

Further, the metal sheet 86 is enclosed in the resin frame member 102.

In the structure, it is possible to more effectively reduce the situation where the first metal separator 42 and the second metal separator 44 are connected together electrically through the metal sheet 86.

The metal sheet 86 is provided between the film body 56 and the reinforcement film 104.

In the structure, the metal sheet 86 can be enclosed in the resin frame member 102 with a simple structure.

### Third Modified Embodiment

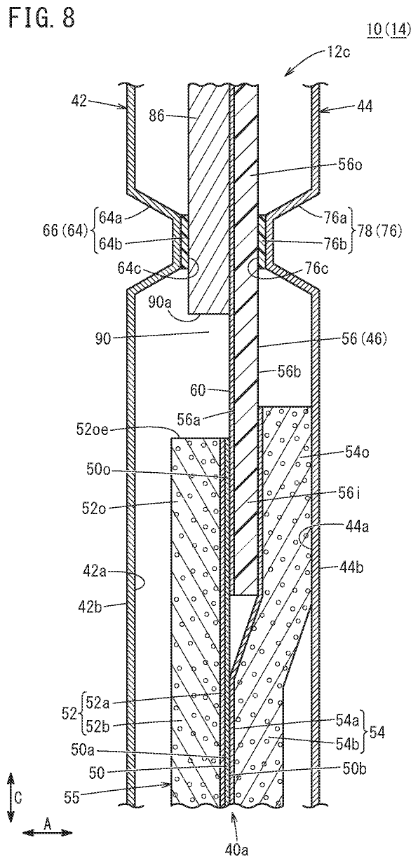

As shown ion FIG. 8, in the power generation cell 12c according to the third modified embodiment, the resin frame member 46 is made up of only the film body 56. That is, the resin frame member 46 does not include the above-described reinforcement film 58. Further, the metal sheet 86 is joined to the surface 56a of the film body 56 by the adhesive layer 60. That is, the metal sheet 86 is provided only on a surface (surface 56a of the film body 56) of the resin frame member 46 where the cathode 52 is positioned, and the metal sheet 86 is not provided on a surface of the resin frame member 46 (surface 56b of the film body 56) where the anode 54 is positioned.

In this case, the seal surface 64c of the seal bead 64 contacts the metal sheet 86. The seal surface 76c of the seal bead 76 contacts the surface 56b of the film body 56. The resin member 64b is an electrically insulating member. In the structure, the same advantages as in the case of the above-described power generation cell 12 are obtained. Further, the structure of the resin frame member 46 can be simplified.

### Fourth Modified Embodiment

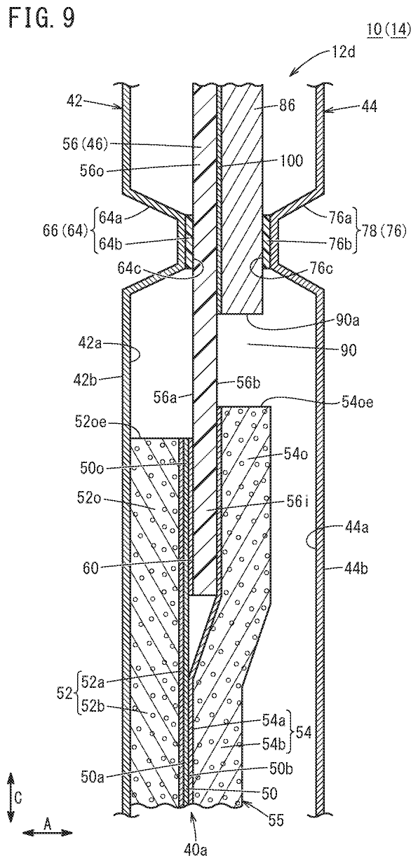

As shown in FIG. 9, in the power generation cell 12d according to the fourth modified embodiment, the resin frame member 46 is made up of only the film body 56. That is, the resin frame member 46 does not include the above-described reinforcement film 58. Further, the metal sheet 86 is joined to the surface 56b of the film body 56 by an adhesive layer 100 made of adhesive. The adhesive layer 100 used herein may be the same as the above-described adhesive layer 60. The metal sheet 86 is provided only on a surface of the resin frame member 46 (surface 56b of the film body 56) where the anode 54 is positioned. The metal sheet 86 is not provided on a surface of the resin frame member 46 (surface 56a of the film body 56) where the cathode 52 is positioned. It should be noted that the adhesive layer 60 is not provided on the outer peripheral portion of the surface 56a of the film body 56.

In this case, the seal surface 64c of the seal bead 64 contacts the surface 56a of the film body 56. The seal surface 76c of the seal bead 76 contacts the metal sheet 86. The resin member 76b is an electrically insulating member.

In the structure, the same advantages as in the case of the above-described power generation cell 12 are obtained. Further, it is possible to simplify the structure of the resin frame member 46.

The present invention is not limited to the above-described embodiments. Various modifications may be made without departing from the gist of the present invention.

The above-described embodiments are summarized as follows:

The above embodiments disclose the fuel cell (12) including: the membrane electrode assembly (40a) including the electrolyte membrane (50), and the cathode (52) and the anode (54) holding the electrolyte membrane (50); and the metal separator (42, 44) stacked on each of both sides of the membrane electrode assembly, wherein the electrically insulating resin frame (46) is provided on the outer peripheral side of the power generation section (55) of the membrane electrode assembly, the seal bead (64, 76) protruding toward the resin frame is formed on the metal separator, the seal bead is configured to prevent leakage of fluid comprising the reactant gas or the coolant, in the state where the tightening load in the stacking direction of the metal separator is applied to the seal bead, and the metal sheet (86) is provided in the portion of the resin frame overlapped with the seal bead as viewed in the stacking direction.

In the above fuel cell, the inner peripheral portion of the resin frame may be held between the outer peripheral portion of the cathode and the outer peripheral portion of the anode; and the metal sheet may be provided only on the surface of the resin frame where the cathode is positioned.

In the above fuel cell, the inner peripheral portion of the resin frame may be held between the outer peripheral portion of the cathode and the outer peripheral portion of the anode, and the metal sheet may be provided only on the surface of the resin frame where the anode is positioned.

In the above fuel cell, the resin frame may include the film body (56) provided on the outer peripheral portion of the power generation section, and the reinforcement film (58) joined to the outer peripheral portion of the film body.

In the above fuel cell, the inner peripheral portion of the film body may be held between the outer peripheral portion of the cathode and the outer peripheral portion of the anode, the reinforcement film may be joined to the outer peripheral portion of the surface of the film body where the cathode is positioned, and the metal sheet is joined to the surface of the reinforcement film on the side opposite to the film body.

In the above fuel cell, the inner peripheral portion of the film body may be held between the outer peripheral portion of the cathode and the outer peripheral portion of the anode, the reinforcement film may be joined to the outer peripheral portion of the surface of the film body where the cathode is positioned, and the metal sheet may be joined to the surface of the film body where the anode is positioned.

In the above fuel cell, the metal sheet may be enclosed in the resin frame.

In the above fuel cell, the resin frame may include the film body provided on the outer peripheral portion of the power generation section, and the reinforcement film stacked on the film body, and the metal sheet may be provided between the film body and the reinforcement film.

In the above fuel cell, the plurality of passages (34a, 34b, 36a, 36b, 38a, 38b) for the fluid may extend through the metal separators in the stacking direction, and the metal sheet may extend around the power generation section and the plurality of passages.

In the above fuel cell, the elasticity of the metal sheet may be higher than the elasticity of the resin frame.

In the above fuel cell, the thickness (d1) of the metal sheet in the stacking direction may be smaller than the thickness (d2) of the portion of the resin frame where the metal sheet is provided.

In the above fuel cell, the metal sheet may be formed in a frame shape which surrounds the power generation section.

In the above fuel cell, the outer peripheral end of the metal sheet may be positioned inside the outer peripheral end of the resin frame over the entire periphery.

The above embodiments disclose the fuel cell stack (10) including the stack body formed by stacking the plurality of fuel cells each including the membrane electrode assembly and the metal separator provided on each of both sides of the membrane electrode assembly, wherein the fuel cell is the above-described fuel cell.

What is claimed is:

1. A fuel cell comprising:
a membrane electrode assembly including an electrolyte membrane, and a cathode and an anode holding the electrolyte membrane; and
a metal separator stacked on each of both sides of the membrane electrode assembly, wherein
an electrically insulating resin frame is provided on an outer peripheral side of a power generation section of the membrane electrode assembly,
a seal bead protruding toward the resin frame is formed on the metal separator,
the seal bead is configured to prevent leakage of fluid comprising a reactant gas or a coolant, in a state where a tightening load in a stacking direction of the metal separator is applied to the seal bead, and
a metal sheet is provided in a portion of the resin frame overlapped with the seal bead as viewed in the stacking direction.

2. The fuel cell according to claim 1, wherein
an inner peripheral portion of the resin frame is held between an outer peripheral portion of the cathode and an outer peripheral portion of the anode, and
the metal sheet is provided only on a surface of the resin frame where the cathode is positioned.

3. The fuel cell according to claim 1, wherein
an inner peripheral portion of the resin frame is held between an outer peripheral portion of the cathode and an outer peripheral portion of the anode, and
the metal sheet is provided only on a surface of the resin frame where the anode is positioned.

4. The fuel cell according to claim 2, wherein
the resin frame includes:
a film body provided on an outer peripheral portion of the power generation section; and
a reinforcement film joined to an outer peripheral portion of the film body.

5. The fuel cell according to claim 4, wherein
an inner peripheral portion of the film body is held between the outer peripheral portion of the cathode and the outer peripheral portion of the anode,
the reinforcement film is joined to an outer peripheral portion of a surface of the film body where the cathode is positioned, and
the metal sheet is joined to a surface of the reinforcement film on a side opposite to the film body.

6. The fuel cell according to claim 4, wherein
an inner peripheral portion of the film body is held between the outer peripheral portion of the cathode and the outer peripheral portion of the anode,
the reinforcement film is joined to an outer peripheral portion of a surface of the film body where the cathode is positioned, and
the metal sheet is joined to a surface of the film body where the anode is positioned.

7. The fuel cell according to claim 3, wherein
the resin frame includes:
a film body provided on an outer peripheral portion of the power generation section; and
a reinforcement film joined to an outer peripheral portion of the film body.

8. The fuel cell according to claim 7, wherein
an inner peripheral portion of the film body is held between the outer peripheral portion of the cathode and the outer peripheral portion of the anode,
the reinforcement film is joined to an outer peripheral portion of a surface of the film body where the cathode is positioned, and
the metal sheet is joined to a surface of the reinforcement film on a side opposite to the film body.

9. The fuel cell according to claim 8, wherein
an inner peripheral portion of the film body is held between the outer peripheral portion of the cathode and the outer peripheral portion of the anode,
the reinforcement film is joined to an outer peripheral portion of a surface of the film body where the cathode is positioned, and
the metal sheet is joined to a surface of the film body where the anode is positioned.

10. The fuel cell according to claim 1, wherein the metal sheet is enclosed in the resin frame.

11. The fuel cell according to claim 1, wherein
the resin frame includes:
a film body provided on an outer peripheral portion of the power generation section; and
a reinforcement film stacked on the film body, and
the metal sheet is provided between the film body and the reinforcement film.

12. The fuel cell according to claim 1, wherein
a plurality of passages for the fluid extend through the metal separators in the stacking direction, and
the metal sheet extends around the power generation section and the plurality of passages.

13. The fuel cell according to claim 1, wherein an elasticity of the metal sheet is higher than an elasticity of the resin frame.

14. The fuel cell according to claim 1, wherein a thickness of the metal sheet in the stacking direction is smaller than a thickness of a portion of the resin frame where the metal sheet is provided.

15. The fuel cell according to claim 1, wherein the metal sheet is formed in a frame shape which surrounds the power generation section.

16. The fuel cell according to claim 15, wherein an outer peripheral end of the metal sheet is positioned inside an outer peripheral end of the resin frame over an entire periphery.

17. A fuel cell stack comprising a stack body comprising a plurality of stacked fuel cells each including a membrane electrode assembly and a metal separator provided on each of both sides of the membrane electrode assembly, wherein
the membrane electrode assembly is formed by holding an electrolyte membrane between a cathode and an anode,
an electrically insulating resin frame is provided on an outer peripheral side of a power generation section of the membrane electrode assembly,
a seal bead protruding toward the resin frame is formed on the metal separator,
the seal bead is configured to prevent leakage of fluid comprising a reactant gas or a coolant, in a state where a tightening load in a stacking direction of the metal separator is applied to the seal bead, and
a metal sheet is provided in a portion of the resin frame overlapped with the seal bead as viewed in the stacking direction.
